(19) United States
(12) Patent Application Publication
(10) Pub. No.: US 2019/0366222 A1
(43) Pub. Date: Dec. 5, 2019

(54) SYSTEM AND METHOD FOR BROADCASTING INTERACTIVE OBJECT SELECTION

(71) Applicant: Joseph Lee, San Mateo, CA (US)

(72) Inventors: Kelvin Yong, San Mateo, CA (US); Joseph Lee, San Mateo, CA (US)

(21) Appl. No.: 15/995,968

(22) Filed: Jun. 1, 2018

(51) Int. Cl. A63F 13/86; A63F 13/87; A63F 13/33; A63F 13/40

(52) U.S. Cl. CPC A63F 13/86; A63F 13/40; A63F 13/33; A63F 13/87

(57) ABSTRACT

The present disclosure relates to systems, devices and methods for presentation of game play videos and object interaction. In one embodiment, a method is provided which includes including receiving game play video data including metadata for at least one game play object. The method may include detecting a user input for selection of an object of the game play video data. The user input can identify at least one of an area of the game play video data that includes a graphical representation of the object. In other embodiments multiple objects may be identified based on user input. The method may include updating presentation of the game play video data to include a graphical representation for data associated with the object. Embodiments are also directed to generating an object identification database for object recognition in game play streams.

### FIELD

The present disclosure relates to systems, methods and devices for broadcast video streams, and in particular to viewing and interaction with game play video streams.

### BACKGROUND

Video streaming services allow for viewing video content over network connections. Video streaming may be used to share content and for broadcasting. The conventional video streaming experience relates to playback of video content. Some developments have included presenting selectable graphical elements, such as a link, to video content overlaying the video. These links allow a user to select the graphical element and provide the user with access to a network location (e.g., url, website, etc.). These features are generally limited to content that is added to the videos, and thus, does not allow for detection or interaction with content of the video. Another existing feature allows for presentation of graphical elements for control, such as for selecting a next or previous video, for example. In addition, the conventional video viewing applications are with respect to viewing single videos. While conventional applications allow for watching multiple videos back-to-back, such as a first episode followed by a second episode, the separate videos that are viewed are two separate content files.

In addition to video viewing, game play broadcasting is another popular activity for viewing game play. Game play broadcasting has become a common online activity. A user may broadcast their own game play for other viewers to watch, or viewers may go to a game play site to watch other users play games. Current applications allow for viewing a broadcast of game play. Typically these broadcasts are passive and do not allow for interaction with elements of the video. As such, the user only views the broadcast and has no control over the content presented. Some gaming applications may allow for viewing different views during game play, such as selection of a first person view, aerial view, etc. However, these functions are with respect to in game operations.

There exists a desire to allow for control and interaction with game play viewing. In many instances, existing games are not coded to allow for control or interaction by a viewer. In addition, the likelihood that existing games would be modified is very low as developers generally do not invest in modifying game code after production.

### BRIEF SUMMARY OF THE EMBODIMENTS

Disclosed and claimed herein are methods, devices and systems for presentation of game play videos and object interaction. One embodiment is directed to a method for game play videos and object interaction including receiving, by a device, game play video data for an electronic game, wherein the game play video data includes metadata for at least one game play object. The method includes presenting, by the device, the game play video data. The method includes detecting, by the device, a user input for selection of an object of the game play video data, wherein the user input identifies an area of the game play video data that includes a graphical representation of the object. The method includes determining, by the device, object data based on the location of the user input and received metadata for the game play video data. The method also includes updating, by the device, presentation of the game play video data to include a graphical representation for the object data.

In one embodiment, the game play video data is received including information identifying the location of at least one object within the game play video data, the information also providing a data profile created for each object.

In one embodiment, the at least one game play object is at least one of a tool, weapon, vehicle, player character, player controlled object, non-player character, and display element in general.

In one embodiment, presenting the game play video data includes outputting the game play video data to a display wherein position of a movable graphical element is detected with respect to a display area of the game play video data.

In one embodiment, the user input is a selection of an area of the game play video data associated with an area for the object, the area for the object corresponding to at least one location provided in information received with the game play video data.

In one embodiment, detecting the user input includes determining at least one frame of the game play video content during the user input.

In one embodiment, determining object data includes decoding data provided in association with the game play video data.

In one embodiment, determining object data includes accessing an object database including object profile data for the game play video data.

In one embodiment, updating presentation of the game play video data includes presenting a graphical element in addition to the game play video data for a selected object, the graphical element presented to provide information of a selected object.

In one embodiment, updating presentation of the game play video data includes presenting a graphical interface including object profile data for each object in the game play video data at the time of user input.

Another embodiment is directed to a device configured to present game play videos with object interaction, the device including an input configured to receive game play video data for an electronic game, wherein the game play video data includes metadata for at least one game play object. The control unit is configured to control presentation of the game play video data. The control unit is configured to detect a user input for selection of an object of the game play video data, wherein the user input identifies an area of the game play video data that includes a graphical representation of the object. The control unit is configured to determine object data based on the location of the user input and received metadata for the game play video data. The control unit is configured to update presentation of the game play video data to include a graphical representation for the object data.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a game play video operations according to one or more embodiments;

FIG. 2 depicts a process for presenting game play videos according to one or more embodiments;

FIG. 3 depicts a graphical representation of a system according to one or more embodiments;

FIGS. 4A-4B depict device configurations according to one or more embodiments;

FIG. 5 depicts a graphical representation of object detection according to one or more embodiments;

FIG. 6 depicts a graphical representation of object identification functions according to one or more embodiments; and

FIG. 7 depicts a process for object detection according to one or more embodiments.

### DETAILED DESCRIPTION OF THE EXEMPLARY EMBODIMENTS

### Overview and Terminology

One aspect of the disclosure is directed to interaction with objects in game play videos. In one embodiment, a game play video refers to video data (including audio) for an electronic game (e.g., video game, etc.). Video streams generated by a device, such as a computer or gaming console, can be provided to one or more entities, such as by way of broadcast, download, live viewing, and video viewing in general. Embodiments described herein are directed to providing object information associated with a game play video. By way of example, the user may select one or more objects presented in the game play video. Selection and interaction of objects may be based on information provided either with the stream of content or as a separate channel of data. Providing the user the ability to select or identify objects, in addition with other functions described herein, can provide a user with the ability to interact and receive additional information for objects that is not provided by mere broadcast of video data. Embodiments are directed to electronic games. However, features may be applied to video broadcasting in general. In addition, in certain embodiments features and operations discussed herein can be applied to gaming video content without having to modify code of the underlying gaming system. General gaming devices that execute code of the game generate output including video and audio that is presented on one screen for the user to operate/control an entity.

Embodiments discussed herein allow for providing object interaction with game videos that are not live. In addition, features described herein may be provided for game videos without requiring the gaming console to generate content for objects. Video and game content may be aggregated to generate an object database. The object database can be used by devices to identify objects and present object information. Presenting object information may be useful to a viewer to enrich the viewing experience beyond passive observation of the gaming content. In one embodiment, a system, methods and device configurations are provided for generating object information that can allow for interaction with gamer play video streams and broadcasts.

In certain embodiments, the methods and device configurations allow for interaction with game play video data (e.g., video stream). The game play video data may be provided with data and information to allow a device to provide functionality for selection and interaction with elements of the video content, without requiring modification of the actual game play video data.

As used herein, a game relates to an electronic game (e.g., video game, computer game, etc.) wherein the game generates video data as output. Video data relates to graphical output for the game and can include audio data and other output of the game. The game may include one or more characters or entities. In addition, the game may include one or more objects. As such, a game play video may include one or more entities and objects. Entities and objects may not appear in each frame. The game may also include background elements that are not entities or objects. Objects may relate to static or movable elements (e.g., tools, weapons, blocks, etc.) which may move or change based on player operation.

Another aspect of the disclosure is directed to providing a solution for recognizing objects in game play videos. Many games have objects, such as tools or weapons that are of interest to the viewer. However, identifying the type of object and details of the object may be difficult without the original instruction manual. In addition, it is difficult for a viewer to receive additional data regarding a video stream. Systems, device configurations and processes are provided for recognizing objects in live and recorded game play videos.

### Exemplary Embodiments

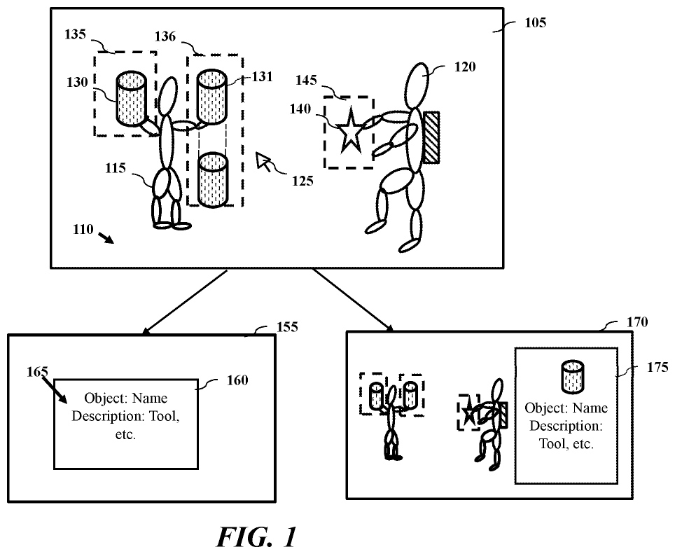

One embodiment of the disclosure is directed to providing game play videos with object interaction. FIG. 1 shows a graphical representation of a display window representing game play video content 105 for an electronic game. Display window may be part of a device, or coupled to a device, as described herein for presentation of game play video content. From the display window, a user may interact with game play video content 105 such that a device updates the presentation of the game play video content to provide information for a selected or identified object, such as updated presentation 155 and updated presentation 170.

According to one embodiment, devices and processes are described herein to view broadcast or downloaded game play video content 105. The devices and processes may also be configured to provide a viewer function to allow for interaction with the game play video content 105. FIG. 1 also shows game play video content 105 including game play elements and device operation according to one or more embodiments.

According to one embodiment, a device may present game play video content 105 including graphical representations for items of the game, such as background 110, character 115, and character 120. The device may also include pointer 125 which may be manipulated based on user input and allow for identification one or more areas, locations and objects of game play video content 105. Game play video content 105 includes an exemplary representation of objects, such as object 130, moving object 131, object 140 and object 150. According to one embodiment, the device may also receive information, such as metadata associated with the objects of game play video content 105 which can be used by the device and/or viewer application to identify objects and provide object information.

According to one embodiment, objects appearing in game play video content 105 may be interacted with. In an exemplary scenario, a user sees an item of interest (e.g., a flashy weapon, etc.), but does not know what it is. Unlike adding metadata to actual video data before transmission for a game specific implementation that requires extensive work from the game developer and client (and that results in a solution that does not scale), solutions are provided herein that allow for object selection and identification irrespective of the game, game status (e.g., in production, out of production, etc.) and game platform.

According to one embodiment, objects may be identified based on object location within one or more frames of game play video content 105. By way of example, user control of pointer 125 to an object location may be used to identify an object. According to another embodiment, user input of pointer 125 (or via another control means) for one or more areas associated with an object may be detected. Game play video content 105 is shown with area 135 for object 130, area 136 for movable object 131 and area 145 for object 140. Accordingly, user controlled identification of area 135 may result in selection of object 130. In certain embodiments, game play objects may be associated with more than one display area, for example objects 130 and 131 may relate to an associated item of the game. As such, selection of one of areas 135 and 136 may be detected to selection for objects 130 and 131. During game play objects may change, be upgraded or be presented differently. As such a viewer may wish to receive additional information for the objects. Areas 135, 136 and 145 may relate to bounding boxes. In certain embodiments, bounding boxes may be presented on screen based on a user input. In other embodiments, the bounding boxes/areas may not be identified by graphical elements.

According to one embodiment, based on a user input that identifies an object, the display may be updated. Display window 155 relates to an updated display window including a graphical element 160 that may be presented including information 165 for an object. Information 165 may include the object name, a description in text and one or more additional features including an image of the object. Graphical element 160 may be an overlay that may be displayed over the game play video content 105. Alternatively, presentation of display window 170 relates to the addition of graphical element 175 including information for an object presented as a companion window with the elements of game play video content 105.

According to one embodiment, the graphical elements presented may be display windows presented in addition to game play video content 105. The graphical elements may be presented for a period of time and then cleared from the display window. In certain embodiments, display windows will remain presented until cleared by a user. Because viewing of game play is typically limited to watching the video content presented, the solutions provided herein allow for interaction and allow for identification in the videos of content that may be of interest.

According to another embodiment, identification of objects may include identification of characters, such as character 115 or character 120. Accordingly, a user selection associated with character position may result in an updated presentation including information for the character.

According to one embodiment, game play video content 105 is presented with metadata for objects. In one embodiment, metadata for game play video content 105 may be embedded into the stream for the video content without changing the actually video data of the game play. By way of example, the metadata may be encoded into a supplemental enhancement information unit of the stream. According to another embodiment, the metadata for objects may be a separate metadata feed. In one embodiment metadata may be requested by a device by transmitting a communication to a server in response to a user input for selected objects.

According to one embodiment, game play video content 105 is presented as part of a broadcast viewing application. Metadata for game play video content 105 may be invisible to a standard video player. A device as described herein may be configured to provide a viewing application (e.g., custom viewer, etc.) to present the additional data to the viewer. The additional information for objects may be displayed in response to user inputs. Information for an object may include the object name, author/credit, use, description, and category and image data for the object. The object information may also include statistics for the object, web link, link to purchase the item, etc.

As will be discussed in more detail below, user inputs for object identification may allow for selection of one or more objects at a time. In one embodiment, objects may be selected by the device tracking position of pointer 125 (e.g., mouse cursor) relative to screen coordinates. The screen coordinates may be compared to known object locations. For example, when pointer 125 is in the bounding box of an identified object, a popup display may be presented to the viewer. According to another embodiment, the user controls may include a button or on screen selection that may trigger display of information for all identified objects in a scene, such as game play video content 105.

The processes, devices and systems described herein provide a solution that is not game specific. As such, game specific metadata is not required or needed to be output by the game itself In addition, metadata for objects can be continually be updated based on training regardless of how linked to video data. When metadata is kept separate from game play video content 105, metadata can be updated independently to provide additional information as the engine is trained. One additional advantage is the ability to avoid expensive operation of transcoding video frames.

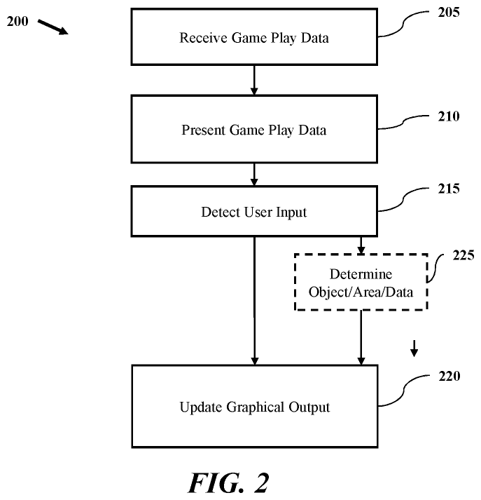

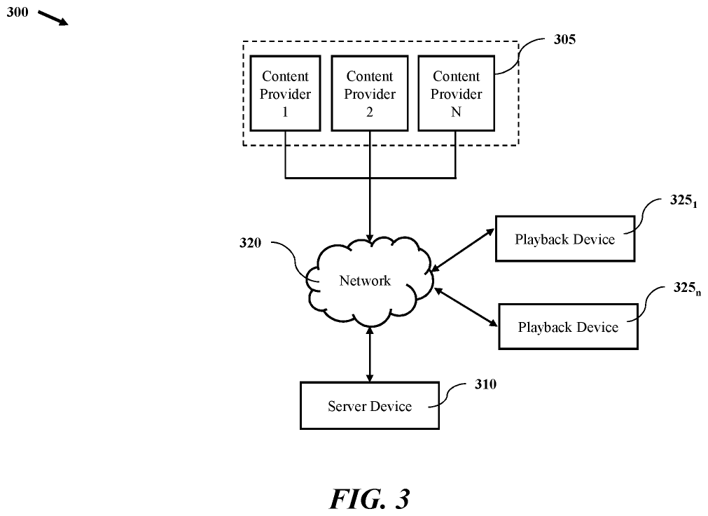

FIG. 2 depicts a process for presenting game play views according to one or more embodiments. According to one embodiment, process 200 may be performed by a device, such as the device providing a display window for game play video content 105 in FIG. 1, the playback devices of FIG. 3, a gaming console, a playback device, a television, computing device, etc. Process 200 may be performed to present game play and allow for interactive object selection. Presentation of game play may be based on game play video data received and information characterizing the game play video data. Process 200 may allow for presentation of game play view selection and control for multiple game types. Game play data received at block 205 may relate to game play video data from previously stored games and/or real time game play.

In one embodiment, process 200 may initiated by receiving game play video data at block 205. In one embodiment a device receives game play video data for an electronic game. The received content can include metadata for one or more objects that may be selectable in the game play video data. In one embodiment, information for the objects of the game play video data relate to data profiles that are not game data (i.e., code of the actual game). Rather, the object metadata may be generated and added to the broadcast of game play video data. According to another embodiment, game play video data is received including information identifying the location of at least one object within the game play video data. The information may provide the frame number(s) and location within each frame. The information may also provide a data profile created for each object. As will be discussed in more detail below, game play objects may each include a data profile providing information about the object, its characteristics and features that may allow for detection of the object in game play videos.

According to one embodiment, process 200 is directed to game play objects including at least one of a tool, weapon, vehicle, player character, player controlled object, non-player character, and display element in general.

At block 210, game play video data is presented. The game play video data is presented by outputting the game play video data to a display. The position of a movable graphical element (e.g., pointer 125) may be detected with respect to a display area of the game play video data. In addition, or separately, user input commands may be associated with button presses or selections of an input on a keyboard or terminal of a device.

In one embodiment, presenting the game play video data includes outputting the game play video data to a display. When the device includes a display, the game play video data is output by the device. Alternatively, when the device is a console, output may be provided to an external display. Each device may include a user interface or controller to allow for positioning of a movable graphical element and deterring the position of the movable graphical elements such as a pointer (e.g., pointer 125). Position of a movable graphical element may be detected with respect to the display area of the game play video data to detect user inputs.

At block 210, a user input is detected for selection of an object of the game play video data. The user input identifies an area of the game play video data that includes a graphical representation of the object. In certain embodiments, the user input is a selection of an area of the game play video data associated with an area for the object, the area for the object corresponding to at least one location provided in information received with the game play video data. A user input may be detected by determining at least one frame of the game play video content during the user input.

At block 220, the device updates presentation of the game play video data to include a graphical representation for the object data. In one embodiment, updating presentation of the game play video data includes presenting a graphical element in addition to the game play video data for a selected object. Within the graphical element information of a selected object may be presented. In another embodiment, updating presentation of the game play video data includes presenting a graphical interface including object profile data for each object in the game play video data at the time of user input.

Process 200 may optionally include determining at least one of an object, area and object data at block 225. The device can determine object data based on the location of the user input and received metadata for the game play video data. Determining object data can include decoding data provided in association with the game play video data. According to another embodiment, determining object data includes accessing an object database including object profile data for the game play video data.

FIG. 3 depicts a graphical representation of a system according to one or more embodiments. System 300 includes content providers, shown as 305 which may be configured to provide video game play data and videos. Server device 310 may be configured to provide one or more streams including game play video data to one or more devices, such as playback devices 325₁₋ₙ by way of communication network 320. Although system 300 is shown including a single server device 310, it should be appreciated that system 300 may include multiple servers and devices. Server device 310 relates to a computing device that may communicate with a communication network, such as network 320 by way of wired and/or wireless communication. Server device 310 may include memory to store gaming video data. In certain embodiments Server device 310 may relate to a back end server for a gaming network and/or video provider in general.

In one embodiment, system 300 receives game play video data from a plurality of devices, such as devices 305. Devices 305 may relate to computers, gaming consoles, etc. Server device 310 may also provide video data, such as game play video data, to one or more devices, such as playback devices 325₁₋ₙ. Functions and capabilities discussed herein of server 105 may provide live feeds of video content. Alternatively, video provided by server 105 may be based on prerecorded video data (e.g., not live).

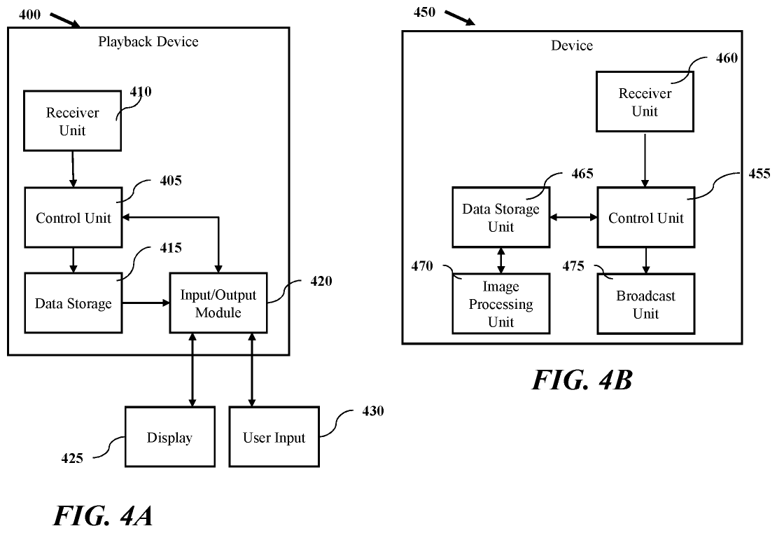

FIGS. 4A-4B depict device configurations according to one or more embodiments. FIG. 4A depicts a graphical representation of a playback device according to one or more embodiments. Device 400 may relate to a playback device, such as a computer, console, television, mobile device, etc. Device 400 includes control unit 405, receiver unit 410, data storage unit 415 and input output module 420. In certain embodiments device 400 includes display 425. In other embodiments display 425 is an external display. Similarly, in certain embodiments, device 400 includes user interface 430. Alternatively user input device 430 may be an external controller. Receiver unit 410 receives a first video stream/metadata package from a server (e.g., storage device 310). Receiver unit 410 may also download other video stream/metadata package either concurrently or as needed from the server. Receiver unit 410 may provide an input to control unit 405. Device 400 stores the video stream(s) in a data storage module 415. The input/output module 420 sends the first video stream/metadata package to display 425.

During playback, the user may use user input 430 to select an object of the game play video data, such as a player tools, shown on display 425. In one embodiment, user input 430 may be a gaming controller, pointing device, etc. User input 430 may also take the form of a gesture recognition camera, touch screen, or other input device. Once the input/output module 420 receives a signal from user input 430, control unit 405 may be signaled to prepare a change of video stream. Control unit 405 determines which object the user selected. For example, using the bounding box metadata and the input coordinates from the input/output module 420. Control unit 405 may then update the presentation to provide information for the selected object. If the video stream/metadata package is not already loaded to the data storage module 415, control unit 405 loads the desired video stream/metadata package from the storage device 415 via a network.

Once the new video stream/metadata package is loaded, control unit 405 determines the current timestamp of the first video stream/metadata package. Control unit 405 can then use the new video stream/metadata package and starting playback on the new video stream/metadata package at the next timestamp in the playback sequence.

FIG. 4B depicts a graphical representation of a server according to one or more embodiments. Device 450 includes control unit 455, receiver unit 460, data storage unit 465, image processing unit 470 and broadcast unit 475. Receiver unit 460 can receive original video output streams from a plurality of gaming devices via a network. Once the video streams are in the data storage unit 465, image processing unit 470 creates an associated metadata tag indicating which objects appear in which frames and where in the frames they appear. Once the video streams have a corresponding metadata tag, the control unit 455 may load one of the video stream/metadata packages at any time and send it to the broadcast unit 475 for transmission to a playback device via a network. The playback device may later request that the control unit 455 load and transmit another video stream/metadata package from the same group.

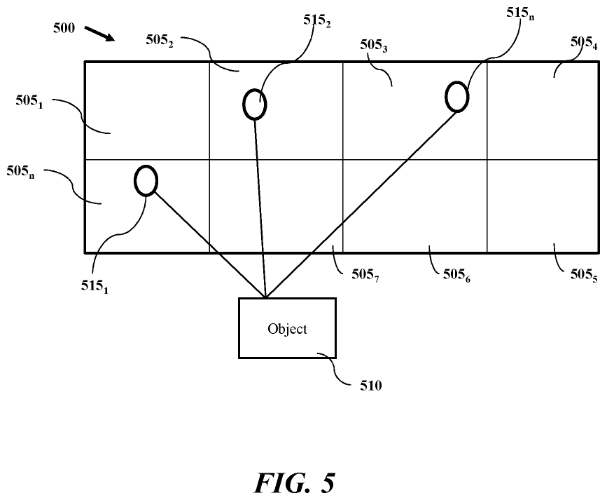

FIG. 5 depicts a graphical representation of object detection according to one or more embodiments. Object detection may be based on one or more processes for object learning. According to one embodiment, a collection of videos, such as videos 505₁₋ₙ are analyzed. Videos 505₁₋ₙ may each relate to the same game. In other embodiments, video analysis may be based on one or more different games. An object identification number, which may be a unique number, may be generated for an object 510 that appears in videos 505₁₋ₙ. Analysis of the object may determine the object from its representation 515₁₋ₙ in several videos. According to one embodiment, machine learning and image analysis may be used to create a generalized solution for recognizing objects in a game. In certain embodiments, image analysis may be based on reverse transformation of the 3-D image into 2-D in order to optimize image recognition.

Once created, object 510 may be assigned a data profile. The data profile may include information that may be displayed with item or linked to a website with information about the item.

Object identification in video data may be based on training (e.g., game training). Game training and object identification may be performed by a developer or community member with interest in a game or object type. In an exemplary embodiment, a collection of broadcast videos linked by the identification of a game (e.g., Game ID, Game name, etc.). The Game identification may be a numeric code that is uniquely assigned to a title. Objects in each game may be created with metadata for at least one of a Game (ID) link, item information, stats, web link(s) etc. In addition to setting a unique ID for each object, images or videos may be selected to train recognition of the object. Training pictures may be linked to the Object ID of the item

According to one embodiment, a networked solution may be employed to analyze all videos that match a Game ID for which an object is associated with. The control unit may include an object recognition algorithm used to identify objects in each frame. Object location is tracked for position and spatial orientation. Once objects are identified, video metadata is created and associated with each frame the object appears in. Video metadata may include both the object ID and coordinates/location of the object video data. Training may be performed for all old and new videos, continually updating the metadata with new training data

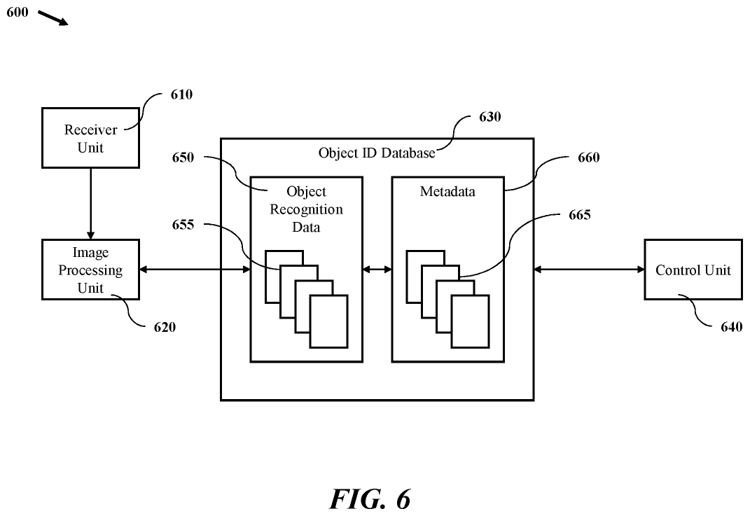

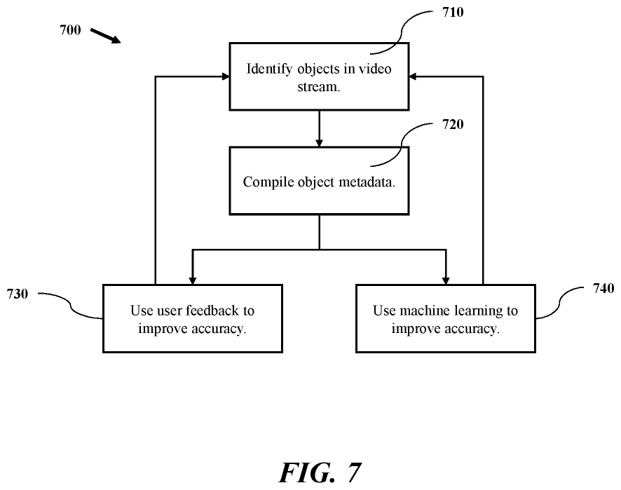

FIG. 6 depicts a graphical representation of iterative object recognition and metadata tagging according to one or more embodiments. In one embodiment, the receiver unit 610 passes video data to the image processing unit 620 for analysis. The image processing unit 620 identifies various objects in the video. FIG. 7 discusses a process for identifying objects. Once the image processing unit 620 has identified all the objects in the video, it passes the identification data to the object ID database 630. In one embodiment, the control unit 640 then gathers metadata associated with the identified objects (e.g. game statistics, usage statistics) and stores that metadata in the object ID database 630. In one embodiment, the metadata 660 is paired with the object recognition data 650, such that the control unit 640 can call the relevant metadata after finding only the object recognition data for a given object.

According to one embodiment, object ID database 630 may be created to provide an object metadata database for objects viewed in a video stream. Object recognition may be performed to identify objects in a video stream. Metadata for each identified object is compiled and used to train a device to recognize other instances of each identified object in a video stream. Video streams may be broadcasted with metadata compiled and trained in the previous steps. In certain embodiments, devices configured for video playback perform object recognition algorithms to find other instances of an identified object to improve object recognition accuracy. Input may be received from a plurality of users to improve object recognition accuracy. Object detection may also use reverse image transformation to improve object recognition accuracy.

FIG. 7 depicts a process for object detection according to one or more embodiments. FIG. 7 depicts a process for iterative object recognition and data collection according to one or more embodiments. Process 700 may be performed by the processor of a playback device (e.g. control unit 405 in FIG. 4A), but it is best coordinated across multiple playback devices by the processor of a server device (e.g. control unit 450 and image processing unit 430 in FIG. 4A).

According to one embodiment, process 700 includes identifying objects seen in a video stream in block 710, compiling metadata regarding the identified objects in block 720, and improving identification accuracy by either using user feedback from playback devices as in block 730 or using machine learning techniques as in block 740. Process 700 may also use the techniques in parallel to achieve the most accurate identification results for block 710.

While this disclosure has been particularly shown and described with references to exemplary embodiments thereof, it will be understood by those skilled in the art that various changes in form and details may be made therein without departing from the scope of the claimed embodiments.

What is claimed is:

1. A method for presentation of game play videos and object interaction, the method comprising:
receiving, by a device, game play video data for an electronic game, wherein the game play video data includes metadata for at least one game play object;
presenting, by the device, the game play video data;
detecting, by the device, a user input for selection of an object of the game play video data, wherein the user input identifies an area of the game play video data that includes a graphical representation of the object;
determining, by the device, object data based on the location of the user input and received metadata for the game play video data; and
updating, by the device, presentation of the game play video data to include a graphical representation for the object data.

2. The method of claim 1, wherein the game play video data is received including information identifying the location of at least one object within the game play video data, the information also providing a data profile created for each object.

3. The method of claim 1, wherein the at least one game play object is at least one of a tool, weapon, vehicle, player character, player controlled object, non-player character, and display element in general.

4. The method of claim 1, wherein presenting the game play video data includes outputting the game play video data to a display wherein position of a movable graphical element is detected with respect to a display area of the game play video data.

5. The method of claim 1, wherein the user input is a selection of an area of the game play video data associated with an area for the object, the area for the object corresponding to at least one location provided in information received with the game play video data.

6. The method of claim 1, wherein detecting the user input includes determining at least one frame of the game play video content during the user input.

7. The method of claim 1, wherein determining object data includes decoding data provided in association with the game play video data.

8. The method of claim 1, wherein determining object data includes accessing an object database including object profile data for the game play video data.

9. The method of claim 1, wherein updating presentation of the game play video data includes presenting a graphical element in addition to the game play video data for a selected object, the graphical element presented to provide information of a selected object.

10. The method of claim 1, wherein updating presentation of the game play video data includes presenting a graphical interface including object profile data for each object in the game play video data at the time of user input.

11. A device configured to present game play videos with object interaction, the device comprising:
an input configured to receive game play video data for an electronic game, wherein the game play video data includes metadata for at least one game play object; and
a control unit coupled to the input, wherein the control unit is configured to
control presentation of the game play video data;
detect a user input for selection of an object of the game play video data, wherein the user input identifies an area of the game play video data that includes a graphical representation of the object;
determine object data based on the location of the user input and received metadata for the game play video data; and
update presentation of the game play video data to include a graphical representation for the object data.

12. The device of claim 11, wherein the game play video data is received including information identifying the location of at least one object within the game play video data, the information also providing a data profile created for each object.

13. The device of claim 11, wherein the at least one game play object is at least one of a tool, weapon, vehicle, player character, player controlled object, non-player character, and display element in general.

14. The device of claim 11, wherein presenting the game play video data includes outputting the game play video data to a display wherein position of a movable graphical element is detected with respect to a display area of the game play video data.

15. The device of claim 11, wherein the user input is a selection of an area of the game play video data associated with an area for the object, the area for the object corresponding to at least one location provided in information received with the game play video data.

16. The device of claim 11, wherein detecting the user input includes determining at least one frame of the game play video content during the user input.

17. The device of claim 11, wherein determining object data includes decoding data provided in association with the game play video data.

18. The device of claim 11, wherein determining object data includes accessing an object database including object profile data for the game play video data.

19. The device of claim 11, wherein updating presentation of the game play video data includes presenting a graphical element in addition to the game play video data for a selected object, the graphical element presented to provide information of a selected object.

20. The device of claim 11, wherein updating presentation of the game play video data includes presenting a graphical interface including object profile data for each object in the game play video data at the time of user input.
